(19) United States
(12) Patent Application Publication
(10) Pub. No.: US 2017/0086423 A1
(43) Pub. Date: Mar. 30, 2017

(54) SECURE SEALABLE TRANSPORTABLE PET FEEDING ASSEMBLY

(71) Applicant: Ron G. WALL, Goodlettsville, TN (US)

(72) Inventor: Ron G. WALL, Goodlettsville, TN (US)

(21) Appl. No.: 15/261,313

(22) Filed: Sep. 9, 2016

Related U.S. Application Data
(60) Provisional application No. 62/235,167, filed on Sep. 30, 2015.

(51) Int. Cl. A01K 5/01

(52) U.S. Cl. CPC A01K 5/0135

(57) ABSTRACT

A transportable pet feeding assembly, for feeding animals, comprising a solid food-safe rigid tray, with raised rigid molded anti-spill containment border edging encircling the tray, whereby the assembly includes flexible re-sealable lids and enamel coated steel food-safe feeding bowls, where the bowls remain mechanically and magnetically secure when placed within rigid molded depressions, in the top surface of the tray, as the molded depressions are designed to fit the designated underside geometry of the designated feeding bowl.

### CROSS-REFERENCE TO RELATED APPLICATIONS

This application claims the benefit of U.S. Provisional App. No. 62/235,167, filed Sep. 30, 2015.

### FIELD OF THE INVENTION

A transportable pet feeding assembly (1), for feeding animals, comprising a solid food-safe rigid tray (2), with raised rigid molded anti-spill containment border edging (7) encircling the tray, whereby the assembly includes flexible re-sealable lids (6) and enamel coated steel food-safe feeding bowls (5), where the bowls remain mechanically and magnetically secure when placed within rigid molded depressions (3), in the top surface of the tray, as the molded depressions are designed to fit the designated underside geometry of the designated feeding bowl. A rare-earth solid magnet (4), affixed (9) within an underside cavity, in the bottom side of the tray, within the molded depression, facilitates anti-spill feeding and anti-spill transporting of the assembly with the lid sealed to the bowl (6) and mechanically/magnetically engaged secured food and water filled bowls; anti-slip feet (8) affixed to the bottom of the tray, restrict movement of the feeding assembly with respect to a floor surface while the anti-slip feet provide an offset from the floor for ease of fingertip access to the tray bottom, in conjunction with the molded anti-spill rigid border edging (7), for lifting, transporting, placing, and/or storing a food and water bowl filled assembly. The assembly includes decorative graphics on the surface of the tray and bowls which may include a decorative tray outline (FIG. 2) shaping for styling aesthetics.

### BACKGROUND OF THE INVENTION

Feeding pets poses unique challenges in maintaining a generally spill free serving station in addition to the filling, transporting, cleaning, and/or storing of such a serving station. Pets will often push while eating out of a serving bowl causing the bowl to slide or tip or will slosh liquids while drinking out of a serving bowl. This leads to unwanted spills of food or liquid disseminating to wood flooring, carpets, or any surface the serving bowl is set upon. Damage to wood flooring may occur from buckling from exposure to liquid spills. Likewise, carpets may absorb liquids into the under padding where damaging mold growth may develop. Food spills of canned soft pet food may foster hygiene issues as bacterial growth or mold may also develop.

Individual pet feeding bowls have been developed to try to contain spillage and to limit the tipping of the bowl as disclosed in US2013/0019808 where a heavy base bowl assembly is intended to stabilize the bowl from pushing while the pet is feeding. The bowl has an upper feeding tray insert to limit the pet to a smaller serving portion and the separate feeding tray is designed to fit within a top opening, with raised side walls, in the heavier bowl assembly. The raised and angled side walls are intended to help direct pet food back into the shallow serving upper tray insert that the pet may drop while feeding. Some of the disadvantages to such a design is that servings are limited to small serving portions; that the design is a multi-piece component structure that requires extra attention to cleaning; that the smaller upper serving tray must be lifted from pushing underneath the bowl and may be spilled in the process; and that the additional fabrication complexity of the metal faceting of the bowl and tray components increases cost. Additional spillage may occur, when transporting the individual small serving tray, as the serving tray does not implement a form of lid sealing.

US2004/0237901 discloses a flexible mat design to address the slippage of a pet bowl, from pushing while feeding, by using a mat of rubber type material, that has a tack surface composition, such that the feeding bowl will rest upon one or more rubber bumps. However, due to the flexible material of such a mat design, any spillage requires lifting the bowl and then hand cleaning of the mat surface. With the array of rubber bumps on the flexible mat and with the decorative rim pattern, hand washing is challenging as there are a number of junctions formed in the geometry of such a design. Such a design precludes adequate cleaning in a dishwasher environment as the mat may flex into an undesireable surface orientation due to flexing. The flexible mat precludes transportability as flexing of the mat, with a feeding bowl or bowls intact, may inadvertently cause greater spillage from tipping or dumping a bowl while lifting or transporting.

US2009/0068423 discloses a mat design where the bottom has a rubber backing layer intended to help secure the mat to a surface as the backing is of a non-skid material. The upper layer of the mat is designed to be food-safe and is also designed to be an easy to clean surface. However, the upper surface of the mat is not designed to prevent any movement of a pet feeding bowl from pushing by the pet while feeding. Thus spillage may occur from the pet pushing the bowl off the edge of the mat. This design also precludes safe transportability as a feeding bowl may slide off of the mat if lifted.

U.S. Pat. No. D386,838 illustrates a pet mat that contains depressions for feeding bowls within the mat. As this pet mat illustration does not indicate any surface bumps or other features to inhibit the sliding of a feeding bowl within the depression areas, the bowl resting area depression edges may inadvertently cause the tipping of a bowl, from the pushing of the bowl by the pet while feeding, to where the bottom of the bowl will catch on the depression boundary, thus cause a tipping action, which may result in a greater spillage.

US2013/0199453 discloses a flexible pet mat assembly, which incorporates imbedded magnetic material within the mat, to help prevent the movement of a bowl while the pet is feeding. However, this flexible mat design prevents a safe transport of the mat with a bowl, from the weight of a bowl containing food or water, placed on the mat's surface, as there is a risk of greater spillage or even a dumping of the bowl to the floor from an unexpected tilting flexure. In addition, this flexible mat assembly, when placed on a slightly tilted surface, will not prevent any spillage, from pet feeding or from bowl placement tipping, which could migrate to the outer edges and flow over the edge to the floor since there is no outer raised boundary edging. A further disadvantage to such a design is that dishwasher cleaning is a problem due to the flexible nature of the mat itself. A further disadvantage to this flexible mat assembly is that magnetic materials tend to degrade in a flexing action. The flexing stresses on the internal crystalline magnetic material is brittle. Loss of magnetic field strength could occur from repeated flexure over time.

What is desired is a pet feeding assembly that provides protection against damage to floors and carpets from all forms of food/water spillage from a pet feeding assembly, including the integrated protection of damage to floors and carpets in lifting, transporting, placing, and/or storing food and/or water to/from a pet feeding area.

### OBJECTS OF DIFFERENT ASPECTS OF THE INVENTIONS

It is one object of one aspect of the invention to provide a substantially improved pet feeding assembly that prevents or minimizes floor or carpet damage from the spillage of food/water by the pets or from lifting, transporting, or placing the assembly while providing an ease of maintaining clean hygiene conditions through the ability to wash the assembly either by hand or in an automatic dishwasher. It is a further object of one object of the invention to provide spill prevention/minimization while lifting, transporting, placing, and/or storage of the full assembly while food and/or water is still within the mechanically and magnetically secured feeding bowls. An additional object of one object of the invention is to provide a pet feeding station through creative tray outline forms and through decorative artwork/graphics with coordinated matching of the artwork/graphics between the components of the full assembly.

### SUMMARY OF THE INVENTIONS

In different aspects of the present inventions, these purposes, are achieved by one or more of providing a rigid tray structure, comprised of a food-safe and dishwasher safe material; one or more molded bowl depressions within the rigid tray structure that are of the same diameter of the lower portion of the feeding bowls; food-safe and dishwasher safe enamel coated steel feeding bowls; a strong rare-earth solid magnet, heat tolerant, that is nickel plated and is adhesively mounted flush underneath and within the center of the molded bowl depression(s) whereby the magnet notably secures the provided enamel coated steel feeding bowls within the matching diameter of the molded bowl depression(s) to minimize or prevent any movement or tipping of the feeding bowls. A flexible plastic re-sealable lid secures to the upper rim of the feeding bowl to seal any food or water within the bowl whereby lifting, transporting, placing and/or storing of the feeding assembly prevents or minimizes any spillage from any such activity or movement from any vehicular traveling conditions. The flexible plastic re-sealable lid provides an additional benefit of preventing the pet from over eating when re-sealed to the feeding bowl after a pet feeding. The re-sealable lid also serves to protect and keep fresh any food left-overs. A substantial continuous border around the full edges of the rigid tray structure adequately contains any spillage from pet feeding and from containing any spillage when transporting the full feeding assembly whereby the substantial continuous border also serves as a convenient and secure lifting grasp point of the full feeding assembly. Anti-slip feet attached to the bottom of the rigid tray structure, which secures or minimizes any tray movement on a floor or carpet surface, whereby the feet provide an offset space for fingertip access to form a convenient and secure hand lifting capability in conjunction with the substantial continuous raised border. Using an attractive tray outline design, with decorative artwork on the tray upper surface and decorative artwork on the feeding bowls serves to improve a pet feeding area in beauty and aesthetics.

### BRIEF DESCRIPTION OF THE DRAWINGS

FIG. 1 is an illustration of a side view of the general features of the secure sealable transportable pet feeding assembly.

FIG. 2 is an illustration of a top view of a decorative dog bone tray outline of the secure sealable transportable pet feeding assembly.

FIG. 3 is an illustration of a top view of a rectangular tray outline of the secure sealable transportable pet feeding assembly.

### DETAILED DESCRIPTION OF THE INVENTION

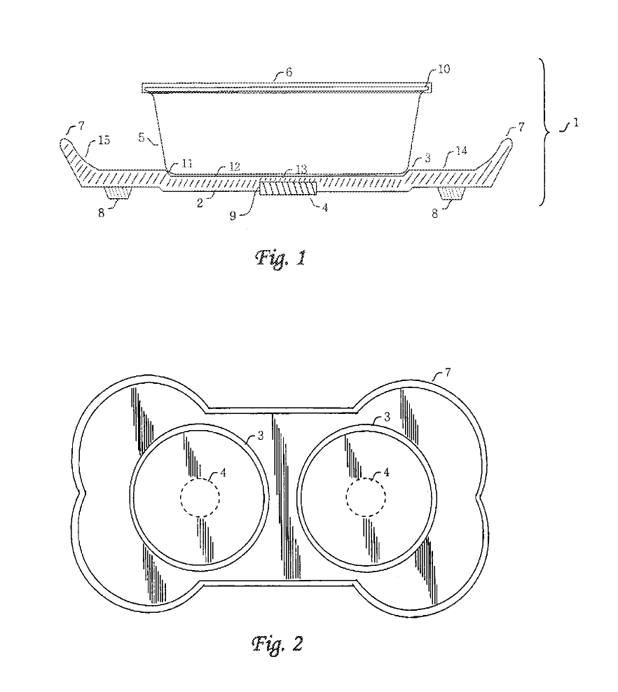

A preferred embodiment of different aspects of the inventions are illustrated in FIG. 1. A rigid tray (2) may be performed through an injection molding or a resin thermosetting molding process, using a food-safe composition material, such as melamine A3 food-safe and dishwasher-safe grade material. The preferred embodiment of the tray thickness would be 3 mm-5 mm. The tray would embody one or more bowl depression moldings (3) designed to match the bottom diameter of the designated feeding bowl size that will accompany the feeding assembly product. In a preferred embodiment, the bottom of a placed feeding bowl will have a bottom-to-sidewall radius such that this radius will contact or be a near-contact to the depression rim (11) when the flat bottom surface of the bowl is flush with the molding top surface (12). Tolerances, for manufacturing variances, of this fit spacing (11) between the tray and the bowl should be within 0 mm minimum to approximately 3 mm spacing. This tolerance allowance insures that the bowl will be flush to the upper surface of the depression as this provides the full benefit of the optimal magnetic attraction between the ferrous steel of the feeding bowl (5) and the rare-earth solid permanent magnet (4). The preferred embodiment of the depression molding depth, measured from the molding top surface (12) with respect to the top surface of the tray (14), would be a minimum of 4-8 mm.

The tray contains a pre-molded cylindrical cavity (9) for the rare-earth solid permanent magnet (4) such that there is a small thickness spacing (13) between the rare-earth solid permanent magnet and the upper surface of the pre-molded depression. The preferred embodiment has a thickness spacing (13) of between 0.4 mm to 0.65 mm. The small thickness of the upper surface of the rare-earth solid permanent magnet to upper surface of the depression provides an optimal attractive force between the ferrous steel feeding bowl bottom to the magnet while still providing a homogeneous surface for the bowl to rest upon. This homogeneous surface optimizes containment of any spillage as this provides a completely sealed depression region. A fully sealed tray surface, besides the full containment of any spillage, provides an easy to clean design. A circular shape of a rare-earth solid permanent magnet is the preferred embodiment as curved edges within the cylindrical cavity are less prone to stress focal points from the lack of corners as would be if the cavity were designed to be rectangular in shape, or any other non-circular outer magnet shape. However, with appropriate epoxy materials, this stress focal point may be somewhat alleviated, thus permitting other embodiments of a differing magnet shape.

Modern solid magnets, whether ferrous magnets, ferric magnets, or permanent magnets, exhibit stress vulnerability from flexing forces leading to cracking due to the brittle crystalline structure composing the magnetic medium. As described in U.S. Pat. No. 6,707,361, spontaneous pyrophoric and/or exothermic reactions, with course neodymium-iron-boron [Nd—Fe—B] particles, may result from these flexing forces. While some reactions occur very suddenly, other reactions may result over time from slow decomposition of the magnetic structure due to flexing forces. Solid crystal structure magnets, whether ceramic, ferric, ferrous, or rare-earth are vulnerable from stress cracking due to their brittle nature. Within an affixed rigid support structure environment, which is mechanically stabilizing the solid magnet body, there is a reduction of the stress vulnerability to the brittle solid magnet from flexing forces.

Manufacturing flexible rare-earth composition magnets may generally include mixing magnet material with a binder resin and forming the mixture into sheets, strips, or net shape parts by compaction molding, roll molding, injection molding and extrusion molding of the mixture. In each of these processes, it is desirable to maximize the particle loading of the magnet material to provide optimum magnetic properties for the permanent flexible magnet. However, there is an inherent difficulty to achieve a bonded magnet having both good magnetic properties with high mechanical flexibility. This difficulty arises from trying to achieve a homogeneous mixture of the binding agents with the magnetic flake particles. These magnetic flakes have a tendency to fracture due to their brittle nature. A resulting poor heat aging property thus results from flexible composition magnets such that some magnets have been limited to room temperature use. The high drying temperatures of a dishwasher environment would need to be avoided for these types of flexible composition magnets. Flexible compositional magnets exhibit poor heat tolerance whereby a safe operating condition is limited to room temperature use.

Due to these considerations, the preferred embodiment employs solid rare-earth permanent magnets selected to have good heat aging properties. This provides for dishwasher tolerant cleaning as part of the dishwashing process where there is typically a heat based drying cycle. The rigid tray provides minimal torsional stress to the permanent magnet. Minimizing flexural stress is important for the life of the product to protect the brittle internal crystalline structure of the magnet. This rigidity protection by the tray additionally protects the invention from spontaneous pyrophoric and/or exothermic reactions and/or slow decomposition of the magnetic structure from repeated flexation. An adhesive is used in the cavity (9) to secure the permanent magnet. A preferred adhesive is Ultra-High-Bond (UHB) dual sided adhesive 0.001 in thick tape from 3M or equivalent dual sided high bond adhesive. An alternate adhesive may be employed using 3M DP110 epoxy or an equivalent based high performance epoxy.

The preferred embodiment utilizes a fully plated solid rare-earth permanent magnet, of an outer nickel plating. The plating protects the magnet from oxidation while providing a degree of aesthetics to the product. The solid rare-earth magnet minimum thickness in the preferred embodiment is 3-5 mm. In the preferred embodiment, the diameter of the solid rare earth permanent magnet is a minimum of 20-25 mm.

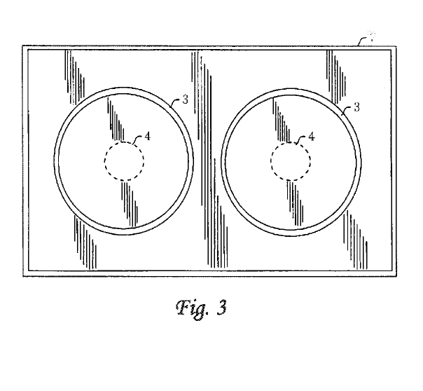

A continuous raised border edging (7) (FIG. 1, 2, 3) is molded as part of the rigid tray. This raised border edging provides a containment boundary from any food or liquid spillage either from pet feeding or from transporting the feeding assembly. This raised border edging also provides a structural strengthening feature to the rigid tray where this strengthening allows for an optimization of the overall tray thickness resulting in production cost savings. The raised border edging additionally serves as a finger or thumb grasping surface for the lifting, transporting, placing, or storing of the pet feeding assembly. Additional strengthening of the rigid tray, through the border edging, is accomplished by creating decorative shaping as illustrated in FIG. 2. This strengthening assists in different size pet feeding assembly dimensions as are required—in the matching tray and bowl assembly configurations—as a larger assembly for larger pets, would need to support a heavier weight from food and/or water filled bowls. The shaping has an additional benefit in that pets may have easier access to the full bowl area as the tray is narrowed to facilitate feeding. In the preferred embodiment, the height of the continuous raised border (7), with respect to the top surface of the tray (14), is from a minimum of 3 mm to 8 mm. In the preferred embodiment, the vertical rise inner surface (15) of the continuous raised border is of a radius curve shape. Anti-slip feet (8) with a minimum of at least 4 individual feet, are affixed to the bottom of the tray, located approximately in the four corner regions of the tray. The outline shape of the feet (8) may be of various types and are not limited to a specific type. The thickness or height of the feet (8), in the preferred embodiment is 8 mm-10.0 mm. The anti-skid feet composition may be of elastomer, thermoplastic elastomer, or rubber.

The pet feeding bowl (5), in the preferred embodiment, is constructed of ferrous steel and has a full surface enamel coating which provides for a food-safe and dishwasher-safe construction. The pet feeding bowl has a press-fit stainless steel rim (10) at the upper lip of the bowl and is shaped such that a flexible plastic re-sealable lid (6) is able to snap-on to engage in a sealing action to the top of the bowl or is removable from lifting from the flexible plastic lid (6) at the underside outer edge. The preferred embodiment of the thickness of the stainless steel snap on rim (10) is from 2-4.5 mm. The flexible plastic re-sealable lid (6) is constructed from food-safe and dishwasher-safe material.

For additional beauty and aesthetics, decorative image graphics may be imprinted on the top surface of the pet feeding tray and/or on the surfaces of the pet feeding bowls. The image graphics are non-toxic, food-safe, and dishwasher-safe.

The detailed description, above, sets forth numerous specific details to provide a thorough understanding of the present invention. However, those skilled in the art will appreciate that the present invention may be practiced without these specific details. In other instances, well known methods, procedures, components, and processes have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

We claim:

1. A secure sealable transportable pet feeding assembly comprising:
(a) a rigid tray with at least one depression whereby a rare-earth solid magnet is affixed within an underside cavity of the center region of the underside of each depression, having a small tray gap between the depression top and the upper surface of the rare-earth solid magnet, whereby the rigid tray includes raised edging that is continuous around the circumference of the tray, and the tray has at least four attached feet composed of skid resistant material mounted generally in the underside corner regions of the tray, whereby the tray is of a composition of non-toxic food-safe and dishwasher safe material; and
(b) at least one pet feeding bowl, constructed of enamel coated ferrous steel, sized to be placeable in one or more depressions within the tray where the bottom region of the bowl fits closely within the diameter of the respective depression, where the pet feeding bowl has a stainless steel upper rim, and whereby a re-sealable flexible plastic lid fastens to the stainless steel upper rim, whereby the pet feeding bowl and the flexible plastic re-sealable lid is of a composition of non-toxic food-safe and dishwasher-safe material;
(c) wherein relative movement of the pet feeding bowl is restricted with respect to the tray by the mechanical edging of the depression and the bowl is further restricted from tipping by the engagement of the rare-earth solid magnet to the underside of the ferrous steel pet feeding bowl, wherein relative movement of the tray is restricted to relative movement of a surface when placed on a surface, wherein the tray with food or water filled pet feeding bowls placed in the tray depressions are spill-safe transportable with the re-sealable flexible plastic lid attached to the top of the pet feeding bowls.

2. A secure sealable transportable pet feeding assembly comprising:
(a) a rigid tray with at least one depression whereby a rare-earth solid magnet is affixed within an underside cavity of the center region of the underside of each depression, having a small tray gap between the depression top and the upper surface of the rare-earth solid magnet, whereby the rigid tray includes raised edging that is continuous around the circumference of the tray, and the tray has at least four attached feet composed of skid resistant material mounted generally in the underside corner regions of the tray, whereby the tray is of a composition of non-toxic food-safe and dishwasher safe material, wherein decorative graphics are imprinted on the upper surface of the tray; and
(b) at least one pet feeding bowl, constructed of enamel coated ferrous steel, sized to be placeable in one or more depressions within the tray where the bottom region of the bowl fits closely within the diameter of the respective depression, where the pet feeding bowl has a stainless steel upper rim, and whereby a re-sealable flexible plastic lid fastens to the stainless steel upper rim, whereby the pet feeding bowl and the flexible plastic re-sealable lid is of a composition of non-toxic food-safe and dishwasher-safe material, wherein decorative graphics are imprinted on the surface of the pet feeding bowl;
(c) wherein relative movement of the pet feeding bowl is restricted with respect to the tray by the mechanical edging of the depression and the bowl is further restricted from tipping by the engagement of the rare-earth solid magnet to the underside of the ferrous steel pet feeding bowl, wherein relative movement of the tray is restricted to relative movement of a surface when placed on a surface, wherein the tray with food or water filled pet feeding bowls placed in the tray depressions are spill-safe transportable with the re-sealable flexible plastic lid attached to the top of the pet feeding bowls.
